(19) United States
(12) Patent Application Publication
(10) Pub. No.: US 2012/0002837 A1
(43) Pub. Date: Jan. 5, 2012

(54) SPEAKER AND METHOD OF ASSEMBLING SAME

(75) Inventor: Tomoharu OUCHI, NAGANO (JP)

(73) Assignee: MINEBEA CO., LTD., KITASAKU-GUN (JP)

(21) Appl. No.: 13/083,920

(22) Filed: Apr. 11, 2011

(30) Foreign Application Priority Data
Jun. 30, 2010 (JP) 2010-149289
Feb. 24, 2011 (JP) 2011-038841

(51) Int. Cl. H04R 1/00; H04R 31/00

(52) U.S. Cl. 381/412; 29/594

(57) ABSTRACT

There is provided a speaker which has a frame structure divided into a first frame and a second frame, wherein tinsel wires are arranged so as not to overlap, with respect to the plane direction, the second frame to which a magnetic circuit is attached, whereby the second frame can be arranged as forward as possible thus enabling reduction of the thickness of the speaker. Also, the first frame and the second frame are both provided with respective frame connection mechanisms and therefore can be easily positioned and connected to each other thus enhancing the workability. The speaker enables further reduction of the thickness without deteriorating input durability and bass range reproduction capability and can be produced with an excellent assembly workability.

### BACKGROUND OF THE INVENTION

1. Field of the invention

The present invention relates to a speaker, particularly a speaker having an elongated shape, and also to a method of assembling such a speaker.

2. Description of the Related Art

A speaker is used not only for a home audio equipment or a car audio equipment but also for various kinds of electronic devices, such as a TV (television) set, a PC (personal computer), a mobile phone, and a game machine. While an electronic device is increasingly becoming reduced in size and weight, the speaker also is requested to have a reduced dimension with a lower profile and to show a higher performance as well.

Since the electronic device has a limited space for accommodating a speaker, the dimension of the speaker is strictly restricted, and it is especially requested that the thickness of the speaker be reduced.

Conventionally, there is provided a low-profile speaker which is structured such that a suspension member (spider) is connected to the outer circumference of a voice coil bobbin (refer to Japanese Patent Application Laid-Open No. 2006-229288 and Japanese Utility Model Patent Application Laid-Open No. S60-142596).

In order to reduce the thickness of a speaker, a speaker structure is further proposed in which a spider is omitted. This structure, however, is apt to cause a rolling phenomenon thus limiting the volume of a reproduced sound. Also, generally, if a spider is omitted, the vibration of a diaphragm is suspended only by a surround, which results in deteriorating the stability. Especially in the case of a speaker having an elongated shape, since a portion of a surround located at a long side is longer than a portion of the surround located at a short side, the rolling phenomenon is caused more easily if a spider is omitted.

Referring to FIG. 11A, a conventional cone speaker is structured such that a tinsel wire 31 to supply an electric signal to a voice coil 30 is connected to a voice coil bobbin 32. In the case of a speaker designed to have a reduced profile, however, the distance between a tinsel wire 31 and a diaphragm 33 is narrowed as shown in FIG. 11B, and therefore the amplitude of the diaphragm 33 is restricted due to the presence of the tinsel wire 31.

The problem described above is often solved by such a method that a lead wire extending from a voice coil is guided to a diaphragm, and then a tinsel wire is fixed to an appropriate portion of the diaphragm in such a manner as not to interfere with the vibration of the diaphragm.

In the case of the aforementioned speaker with a reduced profile shown in FIG. 11B, since the diaphragm 33 is not inclined, there is not a sufficient space behind the diaphragm 33 as well as around a magnetic circuit 34 and a terminal 35, and therefore it has not been easy to secure a work space for guiding a lead wire and also for fixedly attaching a tinsel wire.

Also, in the case of the low-profile flat speaker described in Japanese Patent Application Laid-Open No. 2006-229288 or Japanese Utility Model Patent Application Laid-Open No. S60-142596,as shown in FIG. 11B, the tinsel wire 31 must be arranged in consideration of the location of a spider 36 thus lowering the workability.

Further, in a conventional low-profile flat speaker, the assembling work, such as forming of a lead wire extending from a voice coil, soldering of a tinsel wire to the lead wire for electrical connection therebetween, and fixing of the tinsel wire, must be conducted behind a diaphragm, wherein the work space is limited and therefore the workability has been forced to be very poor. Under the circumstances, if the work space is increased, then the reduction of the must be abandoned.

### SUMMARY OF THE INVENTION

The present invention has been made in order to solve the problems described above, and it is an object of the present invention to provide a speaker which can be produced with an excellent assembly workability and at the same time which enables further reduction of the thickness without deteriorating input durability and bass range reproduction capability.

In order to achieve the object described above, according to an aspect of the present invention, there is provided a speaker which includes: a diaphragm having an elongated plate-like shape; a first frame disposed rearward of the diaphragm; a surround, the inner circumference of which is connected to the diaphragm and the outer circumference of which is connected to the front face of the first frame; a pair of spider units disposed between the diaphragm and the first frame, separated from each other in the direction of the major axis of the first frame, and connected to the diaphragm and the first frame; a voice coil bobbin attached at the center of the diaphragm; a second frame disposed so as to surround the outer circumference of the voice coil bobbin and connected to the first frame; a magnetic circuit attached to the center of the second frame; a voice coil wound around the voice coil bobbin and suspended in a magnetic gap of the magnetic circuit; tinsel wires connected to lead wires extending from the respective ends of the voice coil; and terminals attached to the first frame and connected to the respective ends of the tinsel wires,

In the speaker described above, the second frame includes: a circular cylinder portion which has a hollow and within which the magnetic circuit is attached; and a frame connection mechanism disposed at the outer circumference of the circular cylinder portion and connected to the first frame.

Also, in the speaker, the tinsel wires are arranged at an area that is located radially outward of the outer circumference of the circular cylinder portion of the second frame and that extends along the direction of the major axis of the first frame.

According to the present invention, a speaker is provided which can be produced with an excellent assembly workability and which enables further reduction of the thickness without deteriorating input durability and bass range reproduction capability.

### BRIEF DESCRIPTION OF THE DRAWINGS

FIG. 1 is an exploded perspective view of a speaker according to an embodiment of the present invention;

FIG. 2 is a schematic process block diagram for assembling the speaker of FIG. 1;

FIG. 3 is a schematic process picture corresponding to the process block diagram of FIG. 2;

FIG. 4A is a perspective view of a structure in which a diaphragm and a spider assembly are attached to each other;

FIG. 4B is a perspective view of a process in which third connecting members are removed from the structure of FIG. 4A;

FIG. 5 is a perspective view of a structure in which a lead wire and a tinsel wire are guided and fixed, seen from a rear side of a first frame;

FIG. 6 is an enlarged perspective view of a relevant portion of FIG. 5;

FIG. 7A is a plan view of the structure shown in FIG. 5A;

FIG. 7B is a cross sectional view of FIG. 7A, taken along a line C-C indicated in FIG. 7A;

FIG. 8A is a plan view of a second frame, seen from a rear side thereof;

FIG. 8B is a cross sectional view of FIG. 8A, taken along a line C-C indicated in FIG. 8A;

FIG. 9A is a plan view of the speaker (completed) of FIG. 1, seen from a rear side thereof;

FIG. 9B is a cross sectional view of FIG. 9A, taken along a line C-C indicated in FIG. 9A ;

FIG. 10A is an enlarged plan view of a relevant portion of FIG. 9A;

FIG. 10B is a cross sectional view of FIG. 10A, taken along a line C-C indicated in FIG. 10A;

FIG. 11A is a partial cross sectional view of a conventional cone speaker; and

FIG. 11B is a partial cross sectional view of a conventional low-profile speaker.

### DETAILED DESCRIPTION OF THE INVENTION

An exemplary embodiment of the present invention will hereinafter be described with reference to the accompanying drawings.

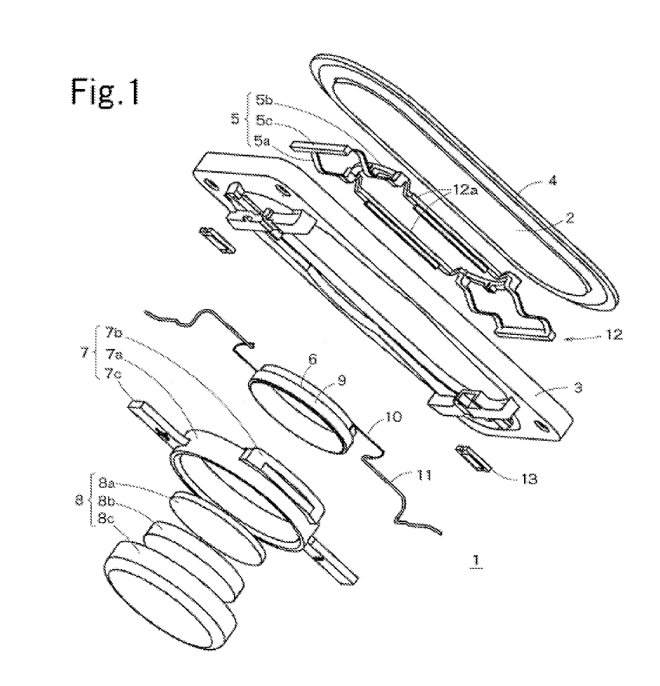

A speaker 1 according to an embodiment of the present invention is shown in FIG. 1 in an exploded perspective manner.

Referring to FIG. 1, the speaker 1 includes: a diaphragm 2 having an elongated plate-like shape; a first frame 3 disposed behind the diaphragm 2; a surround 4 attached at the rim of the diaphragm 2; a pair of spider units 5 attached to the first frame 3 and the diaphragm 2; a voice coil bobbin 6 attached at the center of the diaphragm 2; a second frame 7 connected to the first frame 3; a magnetic circuit 8 attached at the center of the second frame 7; a voice coil 9 wound around the voice coil bobbin 6 and suspended in a magnetic gap of the magnetic circuit 8; two lead wires 10 extending from the voice coil 9; two tinsel wires 11 connected respectively to the lead wires 10; and two terminals 13 attached to the first frame 3 and connected respectively to the ends of the tinsel wires 11.

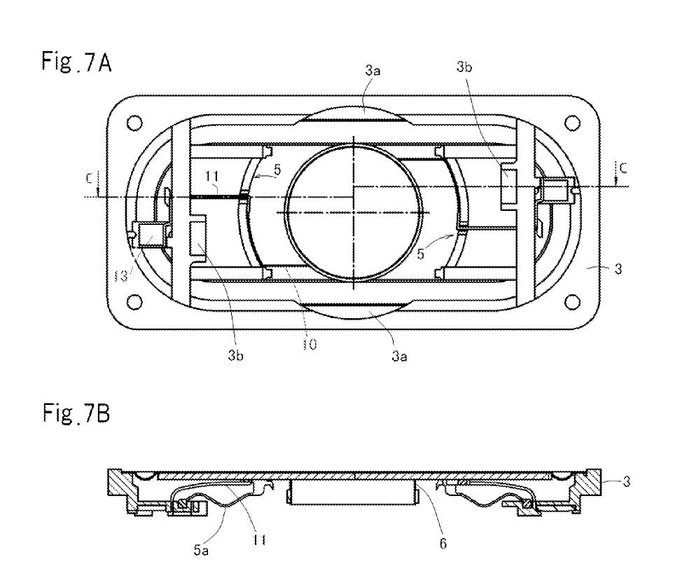

The first frame 3 is shaped so as to define the outline of the speaker 1. The first frame 3 is provided with a frame connection mechanism which is composed of a pair of first fixing recesses 3a and a pair of second fixing recesses 3b (refer to FIG. 7A). Most of the component members other than the first frame 3 are housed within the first frame 3, whereby the thickness dimension of the speaker 1 can be successfully reduced.

The voice coil bobbin 6, which is attached to the diaphragm 2, is located substantially at the center of the first frame 3. The tinsel wire 11 is connected by soldering to the end of the lead wire 10 which extends from the voice coil 9 wound around the voice coil bobbin 6. As will be described herein later, the lead wire 10 and tinsel wire 11 are fixed at a plurality of places of the first frame 3 and a first connecting member 5b of the spider unit 5.

The second frame 7 includes: a circular cylinder portion 7a which has a hollow and within which the magnetic circuit 8 is attached; and a frame connection mechanism which is formed at the outer circumference of the circular cylinder portion 7a and which includes a pair of first fixing blocks 7b protruding radially outwardly from the outer circumference of the circular cylinder portion 7a in the respective opposite directions along the minor axis of the elongated shape of the first frame 3, and a pair of second fixing blocks 7c protruding radially outwardly from the outer circumference of the circular cylinder portion 7a in the respective opposite directions along the major axis of the elongated shape of the first frame 3.

The second frame 7 is connected to the rear face of the first frame 3 by mans of the first and second fixing blocks 7b and 7c and the aforementioned first and second fixing recesses 3a and 3b of the first frame 3, as will be described later.

The magnetic circuit 8 is set inside the circular cylinder portion 7a. The magnetic circuit 8 includes a pole piece 8a, a magnet 8b disposed behind the pole piece 8a, and a pot yoke 8c disposed behind the magnet 8b so as to surround the pole piece 8a and the magnet 8b. The outer circumference of the pot yoke 8c is connected to the inner circumference of the circular cylinder portion 7a of the second frame 7.

Each of the pair of spider units 5 includes: two spider elements 5a arrayed along the direction of the minor axis of the first frame 3; the earlier mentioned first connecting member 5b which connects between respective one ends of the two spider elements 5a and which is fixedly attached to the rear face of the diaphragm 2; and a second connecting member 5c which connects between respective other ends of the two spider elements 5a and which is fixedly attached to the first frame 3.

As will be described herein later, when the speaker 1 is assembled, a spider assembly 12 which is composed such that the pair of spider units 5 are connected via two third connecting members 12a as shown in FIG. 1 is attached to the diaphragm 2. After the spider assembly 12 described above is fixedly attached to the diaphragm 2, the third connecting members 12a are taken away therefrom, which results in that only the pair of spider units 5 of the spider assembly 12 remain attached to the diaphragm 2.

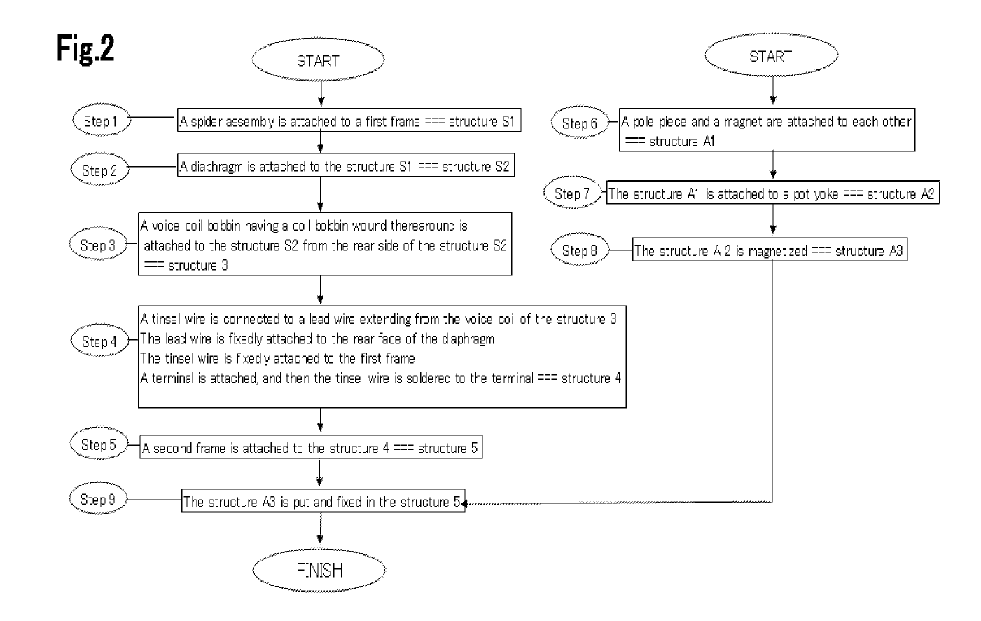

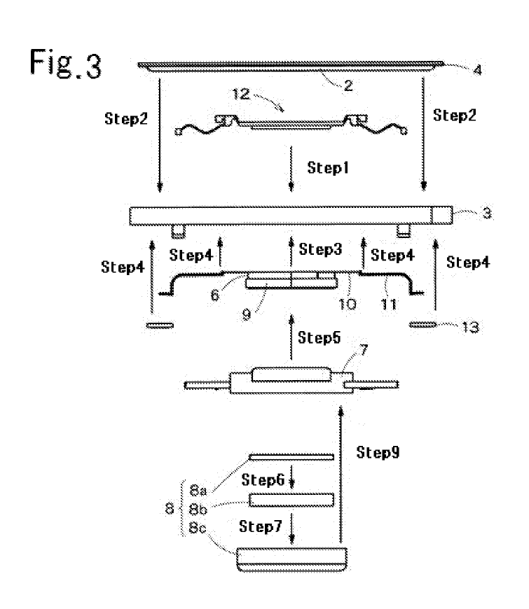

FIG. 2 schematically shows an example process flow of assembling the speaker 1 of FIG. 1, and FIG. 3 shows a picture corresponding to the process flow of FIG. 2.

An example method of assembling the speaker 1 will be described with reference to FIGS. 2, 3 and other relevant drawings.

First, the second connecting members 5c of the spider assembly 12 is attached to the first frame 3 as shown in FIGS. 2 and 3, thus building a structure S1 (Step 1).

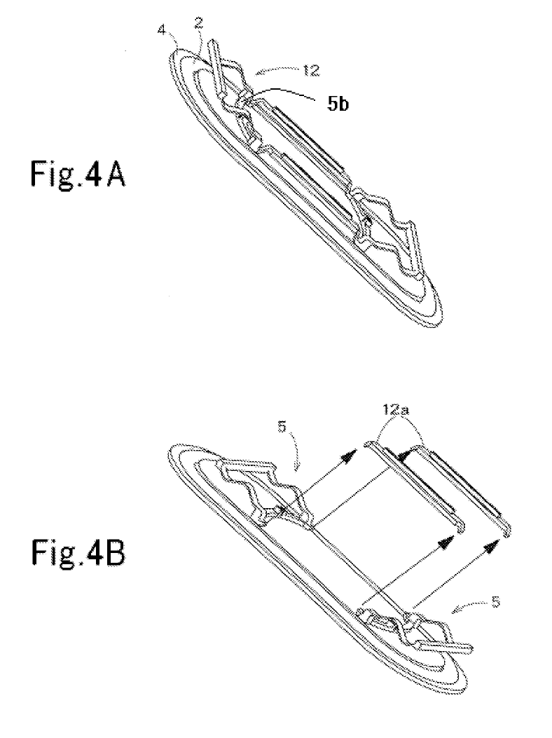

Then, as shown in FIG. 4A, the rear face of the diaphragm 2 to which the surround 4 is attached is connected to the structure S1, specifically to the first connecting members 5b of the spider assembly 12, whereby a structure S2 is built (Step 2). In this connection, the first frame 3 is omitted in FIG. 4A for simplification purpose.

Subsequently, the third connecting members 12a of the spider assembly 12 are removed from the structure S2 as shown in FIG. 4B. Also in FIG. 4B, the first frame 3 is omitted. Here, the third connecting members 12a are removed in order to allow the voice coil bobbin 6 to have the largest diameter possible. That is to say, if the third connecting members 12a remain attached to the structure S2, then the voice coil bobbin 6 to be attached to the diaphragm 2 is forced to have a diameter at most equal to, or smaller than, the distance defined between the two third connecting members 12a.

On the other hand, when the third connecting members 12a are removed as described above, the voice coil bobbin 6 to be attached is allowed to have a diameter equal up to the dimension of the minor axis of the diaphragm 2. Also, when the third connecting members 12a are removed, the weight of the speaker 1 can be reduced.

In this connection, it is also possible that the pair of spider units 5 without the third connecting members 12a are separately attached to the diaphragm 2, in which case, however, it is difficult to position the spider units 5 with respect to the diaphragm 2, and also the pair of spider units 5 must be attached individually, and so the workability is deteriorated.

Then, the voice coil bobbin 6 is attached to the diaphragm 2 from the rear side of the first frame 3, whereby a structure S3 is built (Step 3). In this process, the voice coil 9 is beforehand wound around the voice coil bobbin 6, and the lead wires 10 extending from the respective ends of the voice coil 9 are connected respectively to the tinsel wires 11.

After the voice coil 6 is attached to the diaphragm 2 as described above, the lead wires 10 and the tinsel wires 11 are guided and fixed within the first frame 3 to which the diaphragm 2 and the spider units 5 are fixedly attached, and the ends of the tinsel wires 11 are connected to the terminals 13 (not shown in the relevant figures) thereby building a structure S4 (Step 4).

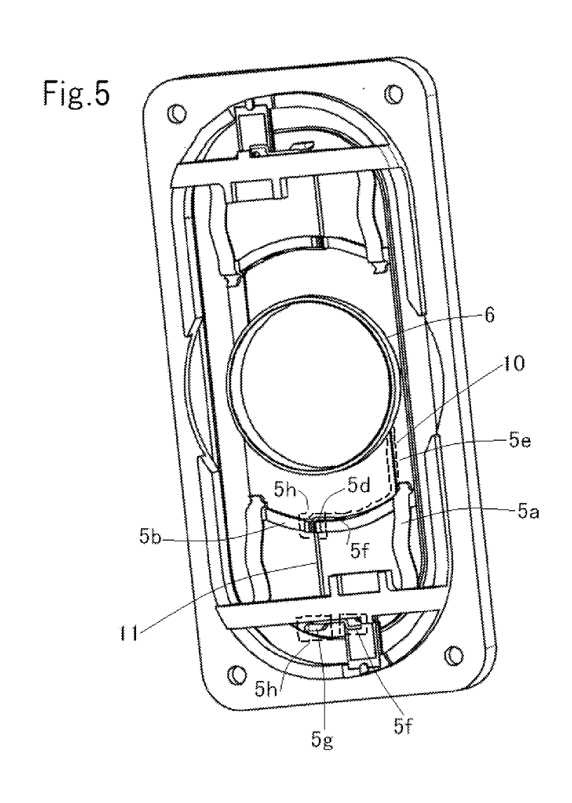

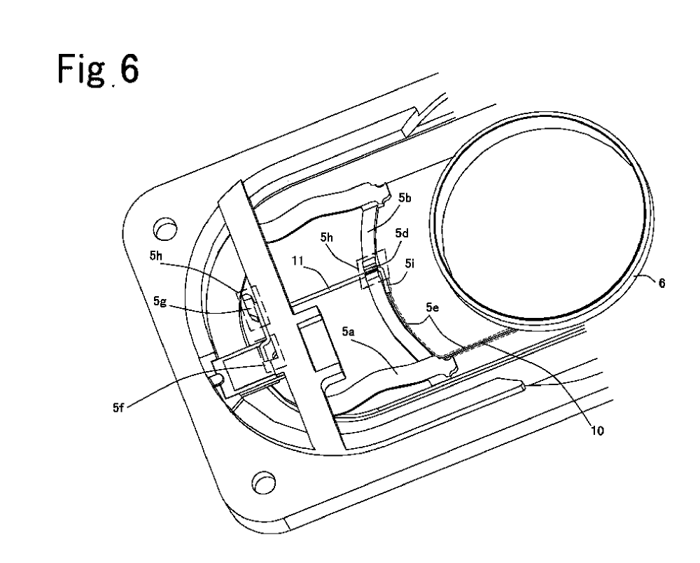

FIG. 5 perspectively shows a structure, seen from the rear side of the first frame 3, in which the lead wires 10 and the tinsel wires 11 are guided and fixed as described above, and FIG. 6 shows a relevant portion of FIG. 5 in an enlarged manner.

As seen from FIGS. 5 and 6, each of the lead wires 10 is pulled out from the voice coil bobbin 6, guided to pass by the one end of the spider element 5a and along the first connecting member 5b and then is connected to the tinsel wire 11 at a point short of a groove 5d which is formed at an off-center portion of the first connecting member 5b. The lead wire 10 is fixed at a portion shown by a broken line 5e indicated in FIG. 5.

Tinsel wire 11 is put through the groove 5d, guided outwardly in the direction along the major axis of the speaker 1, fixedly attached at a positioning and fixing guide 5g, then turned around by 90 degrees to be further guided, and is soldered to the terminal 13 (not shown in FIGS. 5 and 6). In FIG. 6, a portion 5h to which the tinsel wire 11 is adhered and a portion 5f to which the tinsel wire 11 is soldered are shown by respective broken lines.

FIG. 7A shows a plan view of a structure, seen from the rear side of the first frame 3, in which the lead wires 10 and the tinsel wires 11 are guided and fixed (refer to FIG. 5), and FIG. 7B shows a cross section of FIG. 7A, taken along a line C-C indicated in FIG. 7A. Referring to FIG. 7B, the lead wire 11 is located in front of the spider element 5a. The distance between the tinsel wire 11 and the diaphragm 2 is small, but the tinsel wire 11 is fixedly attached at the two portions as shown in FIG. 6 and therefore is prevented from making contact with the diaphragm 2.

As shown in FIG. 7B, all the component members including the voice coil bobbin 6 are fitted within the thickness of the first frame 3. Thus, the thickness of the speaker 1 can be reduced.

After the lead wires 10 and the tinsel wires 11 are guided and fixedly attached as shown in FIG. 7A, the second frame 7 is attached to the first frame 3 from the rear side of the first frame 3, whereby a structure S5 is built (Step 5). The second frame 7 is fixedly attached to the first frame 3 such that the first fixing blocks 7b of the second frame 7 are fitted in the first fixing recesses 3a of the first frame 3, and the second fixing blocks 7c of the second frame 7 are fitted in the second fixing recesses 3b of the first frame 3.

While the Steps 1 to 5 described above are conducted, the magnet 8b is fixedly attached to the pole piece 8a, whereby a structure A1 is built (Step 6). Then, the structure A1 is positioned inside the pot yoke 8c by means of a jig (not shown) and fixed therein, whereby a structure A2 is built (Step 7). In this way, the magnetic circuit 8 is completed. And, the magnetic circuit 8 is magnetized, whereby a structure A3 is built (Step 8).

After the Steps 5 as well as the 8 described above are finished, the outer circumference of the pot yoke 8c of the magnetic circuit 8 is connected to the inner circumference of the circular cylinder portion 7a of the second frame 7 (Step 9).

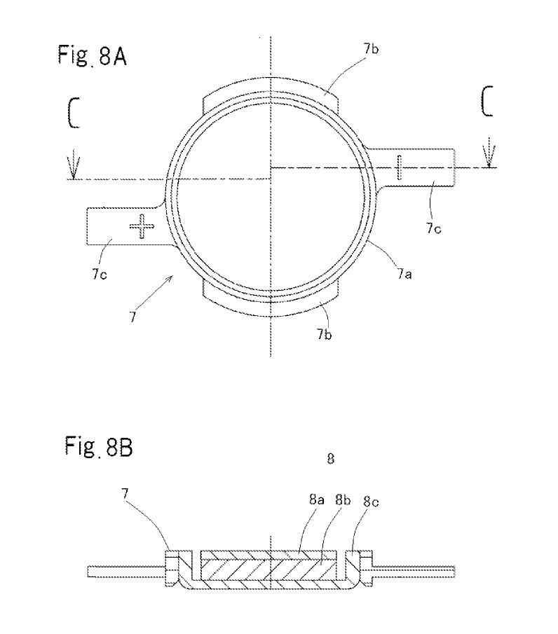

FIG. 8A shows a plan view of an assembly in which the magnetic circuit 8 is attached to the second frame 7, seen from the rear side of the assembly, and FIG. 8B shows a cross section of the assembly of FIG. 8A, taken along a line C-C indicated in FIG. 8A. As seen from FIG. 8B, the magnetic circuit 8 can be attached so as to be fitted almost within the thickness of the second frame 7.

As described above, the magnetic circuit 8 is attached to the second frame 7 connected to the first frame 3. Thus, the speaker 1 shown in FIG. 1 is completed.

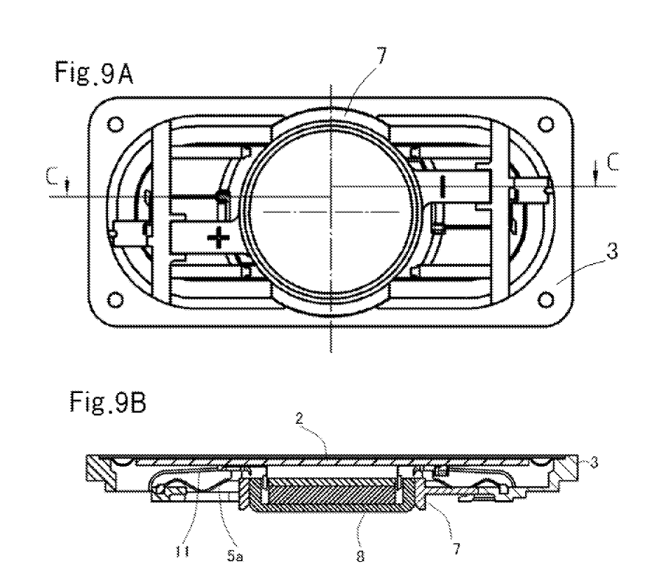

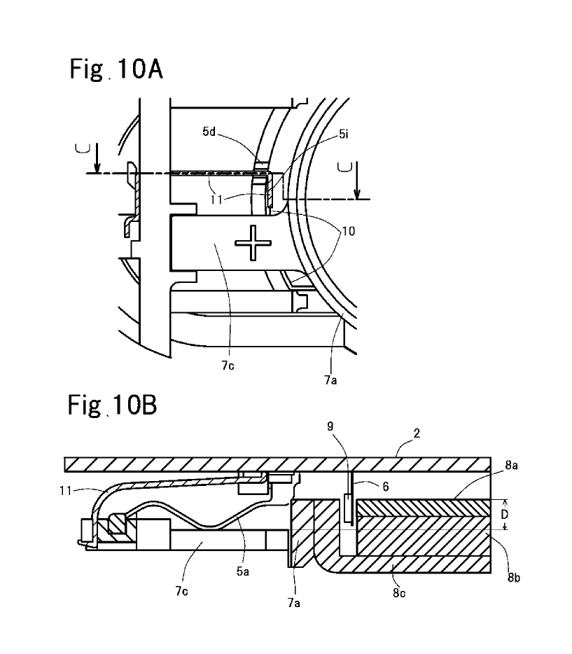

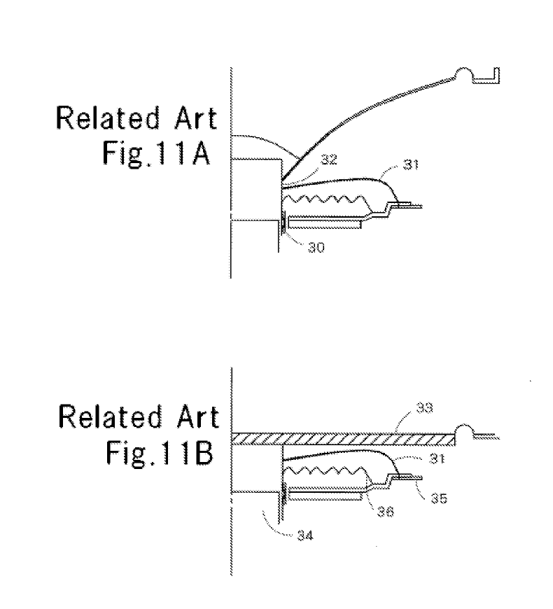

FIG. 9A shows a plan view of the speaker 1 completed as described above, seen from the rear side, and FIG. 9B shows a cross section of FIG. 9A, taken along a line C-C indicated in FIG. 9A. FIG. 10 shows an enlarged plan view of a relevant portion of FIG. 9A, and FIG. 10B shows a cross section of FIG. 10A, taken along a line C-C indicated in FIG. 10A.

Referring to FIG. 9B, it is noted that most of all the component members are housed within the thickness of the first frame 3 though the second frame 7 and the pot yoke 8c of the magnetic circuit 8 protrude slightly rearwardly from the rear face of the frame 3.

Also, as shown in FIG. 10A, the tinsel wire 11 is not located at a place where the circular cylinder portion 7a of the second frame 7 is arranged, and more specifically the tinsel wire 11 is located radially outward of the outer circumference of the circular cylinder portion 7a.

The second fixing block 7c of the second frame 7 is arranged rearward of the tinsel wire 11, but since the second fixing block 7c is arranged rearward of the front end of the circular cylinder portion 7a by a dimension D indicated in FIG. 10B, and also since the tinsel wire 11 and the second fixing block 7c are arranged to be located off each other with respect to the plane direction as shown in FIG. 10A, the tinsel wire 11 and the second fixing block 7c are surely prevented from interfering with each other.

The tinsel wire 11, the circular cylinder portion 7a and the second fixing block 7c are arranged not to overlap one another with respect to the anterior-posterior direction as well as the plane direction in order that the tinsel wire 11, which has a far larger diameter than the lead wire 10, is prevented from making contact with the circular cylinder portion 7a and the second fixing block 7c when the diaphragm 2 vibrates, whereby the second frame 7 is allowed to be entirely positioned as forward as possible, thus contributing to the reduction of the thickness of the speaker 1.

Referring to FIG. 10A, it is noted that a connection point 5i between the lead wire 10 and the tinsel wire 11 is arranged not to overlap the second fixing block 7c with respect to the plane direction. In this connection, however, since the second fixing block 7c is located rearward of the front end of the circular cylinder portion 7a by the dimension D (refer to FIG. 10B), even in the case if the connection point 5i is to be located to overlap the second fixing block 7c with respect to the plane direction, it does not happen that the tinsel wire 11 makes contact with the second fixing block 7c, and therefore the reduction of the thickness of the speaker 1 is not hampered.

Thus, since the speaker 1 according to the present embodiment has a frame structure divided into the first frame 3 and the second frame 7, and since the tinsel wire 11 is arranged so that the tinsel wire 11 and the second frame 7 to which the magnetic circuit 8 is attached do not to interfere with each other with respect to the plane direction, the second frame 7 is allowed to be entirely positioned as forward as possible. Accordingly, the thickness of the speaker can be successfully reduced.

Also, the first frame 3 and the second frame 7 are both provided with the respective frame connection mechanisms, specifically the first frame 3 is provided with the first fixing recesses 3a and the second fixing recesses 3b, and the second frame 7 is provided with the first fixing blocks 7b and the second fixing blocks 7c, whereby the first frame 3 and the second frame 7 can be easily positioned and connected to each other, thus enhancing the workability.

Further, since the spider assembly 12, which is formed such that the pair of spider units 5 are connected to each other via the third connecting members 12a, is first attached to the diaphragm 2 and then the third connecting members 12a is removed, the spider units 5 can be easily attached to the diaphragm, thus enhancing the workability.

In the embodiment described above, each of the pair of spider units 5 is composed of two of the spider elements 5a arrayed along the minor axis direction of the diaphragm 2, but the present invention is not limited in terms of the number of spider elements and each of the spider units 5 may include three or more of the spider elements 5a.

Also, in the embodiment described above, the diaphragm 2 has an elongated shape, but the shape of the diaphragm 2 may be arbitrarily changed.

The present invention has been described with respect to the specific embodiment described above but is not limited thereto and includes various modifications which may occur to a person skilled in the art, wherein the effects and advantages of the present invention also are not limited to what is described above. That is to say, the present invention can be practiced with various additions and alterations and partial omissions without departing from the spirit and scope of the present invention, which can be derived from what are disclosed in the appended claims as well as from its equivalents

What is claimed is:

1. A speaker comprising:
a diaphragm having an elongated plate-like shape;
a first frame disposed rearward of the diaphragm;
a surround, an inner circumference of which is connected to the diaphragm and an outer circumference of which is connected to a front face of the first frame;
a pair of spider units disposed between the diaphragm and the first frame, separated from each other in a direction of a major axis of the first frame, and connected to the diaphragm and the first frame;
a voice coil bobbin attached at a center of the diaphragm;
a second frame disposed so as to surround an outer circumference of the voice coil bobbin and connected to the first frame, wherein the second frame comprises: a circular cylinder portion having a hollow; and a frame connection mechanism disposed at an outer circumference of the circular cylinder portion and connected to the first frame;
a magnetic circuit attached at a center of the second frame so as to be located within the circular cylinder portion;
a voice coil wound around the voice coil bobbin and suspended in a magnetic gap of the magnetic circuit;
tinsel wires connected to lead wires extending respectively from ends of the voice coil, wherein the tinsel wires are disposed radially outward of the outer circumference of the circular cylinder portion of the second frame so as to be located at an area along the major axis of the first frame; and
terminals attached to the first frame and connected to ends of the tinsel wires.

2. A speaker according to claim 1, wherein the frame connection mechanism of the second frame comprises: a plurality of first fixing blocks which protrude from the outer circumference of the circular cylinder portion so as to extend radially outwardly along a direction of a minor axis of the first frame; and a plurality of second fixing blocks which protrude from the outer circumference of the circular cylinder portion so as to extend radially outwardly along the direction of the major axis of the first frame, and wherein the second fixing blocks are disposed rearward of a front face of the magnetic circuit to thereby prevent the tinsel wires from interfering with the second fixing blocks.

3. A speaker according to claim 1, wherein each of the pair of spider units comprises: a plurality of spider elements which are arrayed along a direction of a minor axis of the first frame; a first connecting member adapted to connect respective one ends of the spider elements and attached to a rear side of the diaphragm; and a second connecting member adapted to connect respective other ends of the spider elements and attached to the first frame, and wherein the lead wire is disposed along the first connecting member, and a connection point between the lead wire and the tinsel wire is arranged at an area located along the first connecting member so as not to overlap the circular cylinder portion and the frame connection mechanism of the second frame with respect to a plane direction.

4. A speaker according to claim 1, wherein the pair of spider units are disposed along the major axis of the first frame so as to sandwich the voice coil bobbin.

5. A method of assembling a speaker which comprises: a diaphragm having an elongated plate-like shape; a first frame disposed rearward of the diaphragm; a surround, an inner circumference of which is connected to the diaphragm and an outer circumference of which is connected to a front face of the first frame; a pair of spider units disposed between the diaphragm and the first frame, separated from each other in a direction of a major axis of the first frame, and connected to the diaphragm and the first frame; a voice coil bobbin attached at a center of the diaphragm; a second frame comprising a hollow circular cylinder portion, disposed so as to surround an outer circumference of the voice coil bobbin, and connected to the first frame; a magnetic circuit attached at a center of the second frame; a voice coil wound around the voice coil bobbin and suspended in a magnetic gap of the magnetic circuit; tinsel wires connected to lead wires extending respectively from ends of the voice coil; and terminals attached to the first frame and connected to ends of the tinsel wires, wherein the method comprises:
a process in which a spider assembly built such that the pair of spider units are connected to each other via connecting members is attached to the first frame, then the spider assembly is attached to a rear face of the diaphragm to which the surround is previously attached, and the surround is attached to the front face of the first frame;
a process in which the connecting members of the spider assembly are removed, and then the voice coil bobbin which is previously provided with the voice coil and the lead wires connected with the tinsel wires is attached to the diaphragm from a rear side of the first frame;
a process in which the lead wires and the tinsel wires are guided within the first frame from the rear side of the first frame, and the ends of each of the tinsel wires are connected respectively to the terminals;
a process in which the second frame is connected to the first frame in such a manner that the hollow circular cylinder portion of the second frame surrounds the outer circumference of the voice coil bobbin; and
a process in which the magnetic circuit is attached inside the circular cylinder portion of the second frame from a rear side of the second frame.
